(19) United States
(12) Patent Application Publication
(10) Pub. No.: US 2023/0122520 A1
(43) Pub. Date: Apr. 20, 2023

(54) TOP COVER ASSEMBLY AND BATTERY

(71) Applicant: XIAMEN HITHIUM ENERGY STORAGE TECHNOLOGY CO., LTD., Xiamen (CN)

(72) Inventors: Weidong XU, Xiamen (CN); Nan ZHANG, Xiamen (CN); Yang TANG, Xiamen (CN); Ziqi YI, Xiamen (CN); Zuyu WU, Xiamen (CN)

(73) Assignee: XIAMEN HITHIUM ENERGY STORAGE TECHNOLOGY CO., LTD., Xiamen (CN)

(21) Appl. No.: 17/966,174

(22) Filed: Oct. 14, 2022

(30) Foreign Application Priority Data
Oct. 18, 2021 (CN) 202122506286.9

(51) Int. Cl. H01M 50/16; H01M 50/166; H01M 50/271

(52) U.S. Cl. CPC H01M 50/16; H01M 50/166; H01M 50/271

(57) ABSTRACT

A top cover assembly and a battery are disclosed. The top cover assembly has a cover, a pole and an upper plastic member. The cover is provided with a first installation through hole. The pole operatively penetrates the first installation through hole and an end of the pole is higher than an upper surface of the cover. The upper plastic member is integrally injection-molded on the cover and surrounding the pole.

### CROSS-REFERENCE TO RELATED APPLICATION

This application claims priority to and benefits of Chinese Patent Application No. 202122506286.9, filed on Oct. 18, 2021, which is hereby incorporated by reference in its entirety. No new matter has been introduced.

### FIELD

The present application relates to the field of battery technologies, and in particular, to a top cover assembly and a battery.

### BACKGROUND

A battery includes: a casing with an opening on one side and a hollow interior, an electrode assembly and a top cover assembly. The electrode assembly is accommodated in the casing, and the top cover assembly is used to cover the opening of the casing so that the electrode assembly is installed in the casing. The top cover assembly includes an upper plastic member, a cover, a lower plastic member and a pole. The lower plastic member is fixed on a lower surface of the cover to insulate the cover from the electrode assembly. The upper plastic member is fixed on an upper surface of the cover. One end of the pole is fixed with the lower plastic member and is electrically connected with the electrode assembly, and the other end of the pole is fixed on the cover through the cover and the upper plastic member in sequence.

The upper plastic member is directly sleeved on the pole. However, during a long-term use and handling of the battery, the pole and the upper plastic member are prone to being separated, thereby affecting the connection stability of the top cover assembly.

### SUMMARY

In view of the above deficiencies, the present application provides a top cover assembly and a battery, which can improve the connection stability between a pole and an upper plastic member, thereby improving the service life and safety of the battery.

In order to solve at least the above problems, in a first aspect, the present application provides a top cover assembly, including:

a cover, provided with a first installation through hole;

a pole, configured to penetrate through the first installation through hole, and one end of the pole is higher than an upper surface of the cover;

an upper plastic member, integrally injection-molded on the cover and surrounding the pole.

In the present application, the upper plastic member is integrally injection-molded on the cover, so that the upper plastic member and an outer peripheral surface of the pole and the upper surface of the cover can be closely attached and fixed. As a result, the connection stabilities between the upper plastic member and the pole and between the upper plastic member and the cover are both improved, and the risk of the upper plastic member being detached from the pole or the cover during the use of the battery is reduced, thereby the service life of the battery is ensured and the usage safety of the battery is improved.

In an embodiment, the upper plastic member includes a first portion and a second portion, the second portion is located on the upper surface of the cover, and the first portion is located in the first installation through hole.

Therefore, the first portion of the upper plastic member is located in the first installation through hole, and the second portion of the upper plastic member is located on the upper surface of the cover. On the one hand, the assembly accuracy between the pole body and the first installation through hole is reduced. On the other hand, through injection molding the upper plastic member, the first portion of the upper plastic member can be closely attached and fixed to an outer peripheral surface of the pole body and an inner peripheral surface of the first installation through hole, respectively, thereby improving the connection stabilities between the upper plastic member and the pole and between the upper plastic member and the cover, as well as stability of connection with the lower plastic member.

In an embodiment, the pole includes a pole body and a limiting portion connected to one end of the pole body, the limiting portion abuts against a lower surface of the cover, and the pole body is engaged with the upper plastic member, thereby firmness of a connection between the pole and the upper plastic member is improved.

In an embodiment, an engagement structure staggered in a vertical direction is provided between the an outer peripheral surface of the pole body and an inner peripheral surface of the upper plastic member, and the engagement structure limits movements of the pole in a first direction. The engagement structure includes a first engagement portion arranged on an outer peripheral surface of one end of the pole, and a second engagement portion arranged on the first portion of the upper plastic member. The first engagement portion is engaged with the second engagement portion.

The upper plastic member has a second installation through hole, and the second installation through hole includes a first through hole and a second through hole that communicate with each other. The first through hole is located in the first portion. Since the pole body is provided with a first engagement portion, during injection molding of the upper plastic member, the second engagement portion will be formed on an inner peripheral surface of the first through hole in the first portion. The first engagement portion is engaged with the second engagement portion, so that the upper plastic member can be fixedly connected with the pole body.

Therefore, the first engagement portion is arranged on the pole body, so that the second engagement portion is formed at the first through hole during the injection molding of the upper plastic member injection, and the processing of the second engagement portion is omitted. At the same time, by arranging the first engagement portion to be engaged with the second engagement portion, a stable connection between the upper plastic member and the pole body during the use of the battery can be ensured.

In an embodiment, the first engagement portion is an annular groove, and the second engagement portion is an annular boss; or,

the first engagement portion is an annular boss, and the second engagement portion is an annular groove.

When the first engagement portion is an annular groove, the upper plastic member may enter the annular groove during an injection molding process of the upper plastic member, and an annular boss corresponding to the annular groove may be formed on the inner peripheral surface of the first through hole. When the first engagement portion is an annular boss, the annular boss is higher than the upper surface of the cover. During the injection molding process of the upper plastic member, the upper plastic member may enter a space between the upper surface of the cover and the annular boss, thus an annular boss corresponding to the annular groove is formed on the inner peripheral surface of the first through hole. Thereby, the processing of the upper plastic member can be simplified.

In an embodiment, a peripheral surface of one end of the pole body away from the limiting portion is surrounded with a plurality of limiting grooves, and an extension direction of each limiting groove and an extension direction of the pole body are parallel. The second portion of the upper plastic member has a plurality of limiting protrusions, and the plurality of limiting grooves cooperates are engaged with the plurality of limiting protrusions one by one.

Thereby, circumferential movement of the upper plastic member relative to the pole body can be prevented through engagement of the plurality of limiting grooves and the plurality of limiting protrusions one by one.

In an embodiment, the top cover assembly further includes a sealing ring sleeved on the pole body, and an upper surface of the sealing ring includes a first step surface close to the pole body and a second step surface away from the pole body. The first step surface abuts against the lower surface of the cover, the second step surface abuts against the lower surface of the upper plastic member, and a lower surface of the sealing ring abuts against the upper surface of the limiting portion.

By providing the sealing ring, electrolyte in the battery can be effectively sealed.

In an embodiment, the upper surface of the cover is provided with a protrusion portion surrounding the first installation through hole, and the protrusion portion has a shape of a box. A surface of the upper plastic member toward the cover is provided with an accommodation groove, and the protrusion portion is inserted in the accommodation groove.

Therefore, by arranging the box-shaped protrusion portion on the upper surface of the cover, during a process of injection molding the upper plastic member on the cover, the accommodation groove corresponding to the box-shaped protrusion portion can be formed on the surface of the upper plastic member toward the cover. The upper plastic member can be fixedly arranged on the upper surface of the cover by means of the accommodation groove cooperating with the box-shaped protrusion portion, and at the same time, the processing of the upper plastic member can be simplified.

In an embodiment, the upper surface of the cover is provided with a recessed portion, and a part of a surface of the second portion toward the cover is located in the recessed portion.

A height of the upper plastic member can be reduced, thereby making a structure of the top cover assembly more compact.

In an embodiment, material of the upper plastic member is PPS plastic.

PPS plastic is a thermoplastic special engineering plastic with excellent comprehensive properties, and has advantages of high temperature resistance, corrosion resistance and excellent mechanical properties.

Therefore, by selecting PPS plastic as a molding material of the upper plastic member, high temperature resistance and corrosion resistance of the upper plastic member can be effectively improved, so that a service life of the upper plastic member is improved, and a service life of the top cover assembly is increased.

In an embodiment, a recessed portion is provided on the upper surface of the cover, and the second portion is located in the recessed portion.

By arranging the recessed portion, a height of the upper plastic member can be reduced, thereby an overall height of the top cover assembly is reduced and the structure of the top cover assembly is more compact.

In an embodiment, the upper plastic member includes a positive electrode upper plastic member and a negative electrode upper plastic member, and a material of the positive electrode upper plastic member further includes conductive carbon.

Therefore, the positive electrode upper plastic member can fix an end of a positive pole away from the limiting portion, and the negative electrode upper plastic member can fix an end of a negative pole away from the limiting portion.

In addition, a material of the limiting portion of the positive pole is aluminum, and a material of the limiting portion of the negative pole is copper, and conductivity of copper is stronger than that of aluminum. Therefore, in order to ensure consistency of the conductivity of the positive pole and the negative pole, it is necessary to improve the conductivity of the positive pole. In this embodiment, since the conductive carbon has conductivity, by doping the conductive carbon in the positive electrode upper plastic member, a resistance of the positive electrode upper plastic member can be reduced to a certain extent, thereby the consistency of the conductivity of the positive pole and the negative pole is ensured.

In an embodiment, a negative electrode logo is provided on a surface of the negative electrode upper plastic member away from the cover, and a positive electrode logo is provided on a surface of the positive electrode upper plastic member away from the cover. Therefore, it is convenient for a user to distinguish the positive electrode and negative electrode of the plastic.

In a second aspect, the present application further provides a battery including the top cover assembly according to the first aspect.

Since the battery provided by the present application adopts the top cover assembly of the first aspect, this embodiment can improve the service life and usage safety of the battery by improving the connection stability between the pole and the upper plastic member.

### BRIEF DESCRIPTION OF THE DRAWINGS

In order to illustrate the technical solutions of the embodiments of the present application in a clearer manner, the drawings desired for describing the embodiments of the present application will be described hereinafter briefly. Obviously, the following drawings merely relate to some embodiments of the present application, and based on these drawings, a person skilled in the art may obtain the other drawings without any creative effort.

FIG. 1 is an exploded view of a top cover assembly provided by an embodiment of the present application;

FIG. 2 is a schematic view of assembling of a top cover assembly provided by an embodiment of the present application;

FIG. 3 is a sectional view at A-A of FIG. 2;

FIG. 4 is a partial enlarged view at B in FIG. 3;

FIG. 5 is a schematic view of a pole provided by an embodiment of the present application;

FIG. 6 is a schematic view of an upper plastic member provided by an embodiment of the present application;

FIG. 7 is a partial enlarged view of a cover provided by an embodiment of the present application;

FIG. 8 is a front view of a top cover assembly provided by an embodiment of the present application; and

FIG. 9 is an exploded view of a battery provided by an embodiment of the present application.

### DESCRIPTION OF REFERENCE NUMERALS

10—battery;
100—top cover assembly; 110—cover; 111—first installation through hole; 112—protrusion portion; 113—recessed portion; 120—upper plastic member; 120a—positive electrode upper plastic member; 120b—negative electrode upper plastic member; 1201—cross-shaped groove; 1202—longitudinal groove; 121—first portion; 122—second portion; 123—second installation through hole; 124—accommodation groove; 125—second engagement portion; 1251—annular groove; 1251a—limiting protrusion; 130—pole; 130a—positive pole; 130b—negative pole; 131—pole body; 1311—annular boss; 1311a—limiting groove; 132—limiting portion; 133—first engagement portion; 140—lower plastic member; 150—sealing ring; 151—first step surface; 152—second step surface;
200—electrode assembly;
300—casing; 310—opening; 320—accommodating cavity.

### DETAILED DESCRIPTION OF EMBODIMENTS

Hereinafter, the technical solutions in the embodiments of the present application will be described clearly and thoroughly in conjunction with the drawings in the embodiments of the present application. Obviously, the described embodiments are merely some of the embodiments of the present application, but not all of the embodiments. Based on the embodiments in the present application, all other embodiments obtained by a person of ordinary skill in the art without creative efforts should fall within the protection scope of the present application.

In the present application, the direction or positional relationship indicated by terms “on/above”, “under/below”, “left”, “right”, “front”, “back”, “top”, “bottom”, “inside”, “outside”, “vertical”, “horizontal”, “lateral”, “longitudinal”, etc. is the direction or positional relationship based on that shown in the drawings. These terms are primarily intended to better describe the present application and its embodiments and are not used to define that the indicated device, element or component must have a particular direction, or be constructed and operated in a particular direction.

Moreover, some of the terms may be used to indicate other meanings in addition to the direction or positional relationship, for example, the term “on/above” may also be used to indicate a certain dependency or connection relationship in some cases. For those of ordinary skill in the art, the specific meanings of the terms in the present application may be understood according to specific situations.

In addition, the terms “install”, “arrange”, “provide”, “provided with”, “connect” and “couple” should be understood broadly. For example, it can be a fixed connection, a detachable connection, an integral structure, a mechanical connection, an electrical connection, a direct connection, an indirect connection through an intermediate medium, or a communication between two devices, elements or components. For those of ordinary skill in the art, the specific meanings of the above terms in the present application can be understood according to specific situations.

In addition, the terms “first”, “second”, etc., are used primarily to distinguish different devices, elements or components (the specific type and construction may be the same or different) and are not used to indicate or imply the relative importance or quantity of the indicated device, element or component. Terms like “multiple”/“a plurality of” refer to the number of two or more than two, except for clear and particular restriction.

A battery includes a casing with an opening on one side and a hollow inside, an electrode assembly and a top cover assembly. The electrode assembly is accommodated in the casing, and a top cover is used to cover the opening of the casing, so that the electrode assembly is installed in the casing.

The top cover assembly includes an upper plastic member, a cover, a lower plastic member and a pole. The lower plastic member is fixed on a lower surface of the cover for insulating and assembling the electrode assembly and the cover. The upper plastic member is fixed on an upper surface of the cover. One end of the pole is fixed with the lower plastic member and is electrically connected with the electrode assembly, and the other end of the pole is fixed on the cover through the cover and the upper plastic member in sequence.

The electrode assembly includes an electrode unit and a tab, and the electrode unit includes a positive pole piece, a separator and a negative pole piece. Among them, the electrode unit has two structures. In one structure, the negative pole piece, the separator and the positive pole piece are stacked in sequence to form an unpackaged electrode unit, and the electrode unit has a laminated structure. In the other structure, the negative pole piece, the separator and the positive pole piece are stacked and wound in sequence to form the unpackaged electrode unit, that is, the electrode unit has a wound structure.

The upper plastic member is typically directly sleeved on the pole. During a long-term use and handling of the battery, the pole and the upper plastic member are easily separated, thereby the service life and safety of the battery are effected.

In view of this point, the embodiment of the present utility provides a top cover assembly and a battery, which can improve the connection stability between a pole and an upper plastic member, thereby improving the service life and safety of the battery.

The top cover assembly and the battery are described in detail below through exemplary embodiments.

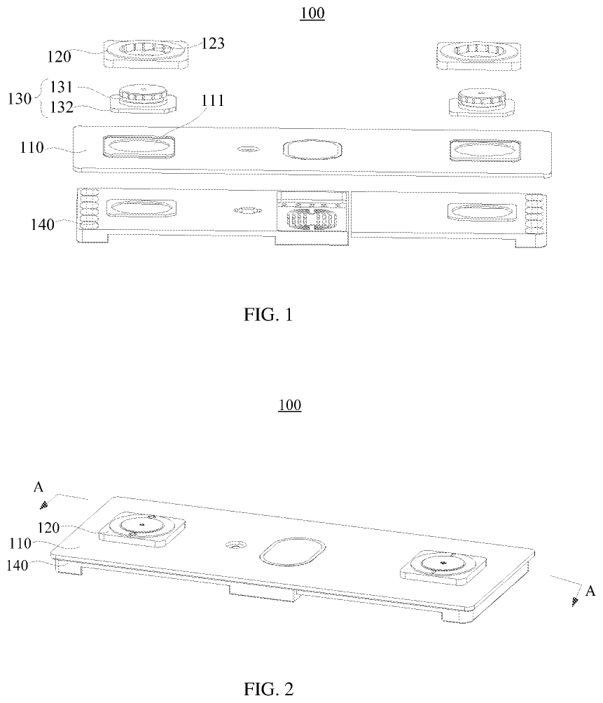

The embodiment of the present application provides a top cover assembly 100. As shown in FIG. 1 and FIG. 2, the top cover assembly 100 includes a cover 110, a pole 130 and an upper plastic member 120. The cover 110 is provided with a first installation through hole 111. The pole 130 is configured to penetrate through the first installation through hole 111, and one end of the pole 130 is higher than an upper surface of the cover 110. The upper plastic member 120 is integrally injection-molded on the cover 110 and surrounding the pole 130.

In this way, the upper plastic member is integrally injection-molded on the cover, so that the upper plastic member can be closely attached and fixed to a peripheral surface of the pole and the upper surface of the cover. As a result, the connection stabilities between the upper plastic member and the pole and between the upper plastic member and the cover are both improved, and the risk of the upper plastic member being detached from the pole or the cover is reduced during the use of the battery, thereby the service life of the battery is ensured and the usage safety of the battery is improved.

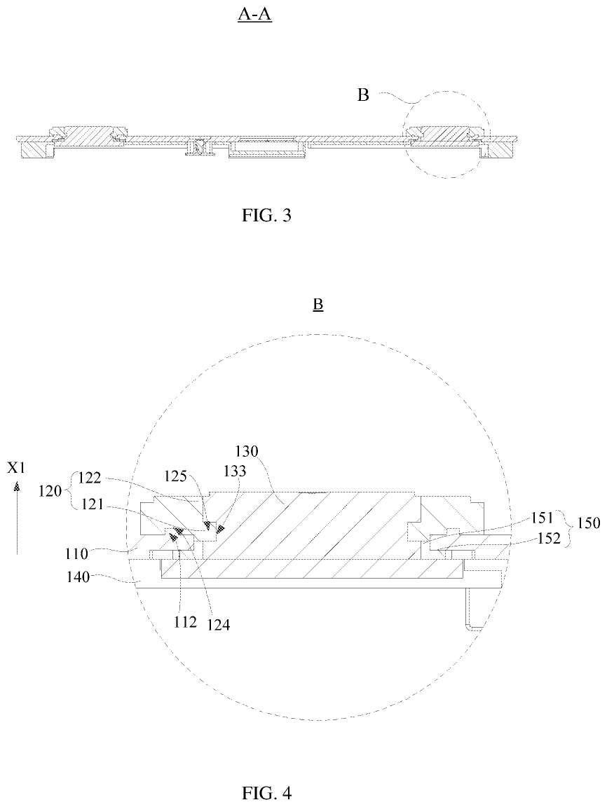

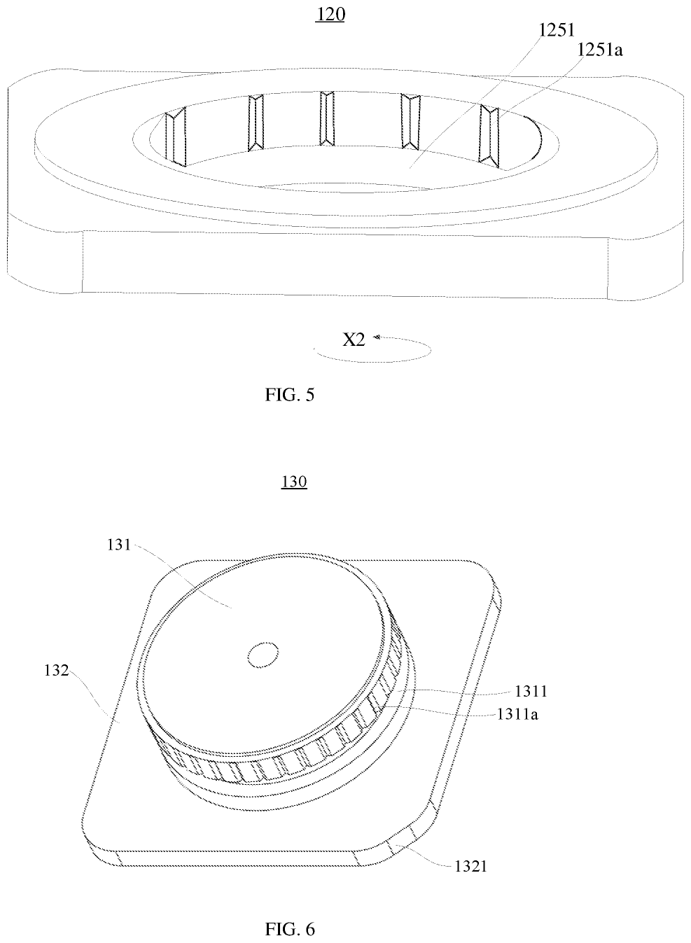

Referring to FIG. 3, FIG. 4 and FIG. 5, the pole 130 includes a pole body 131 and a limiting portion 132 connected to one end of the pole body 131. The limiting portion 132 abuts against a lower surface of the cover 110. The pole body 131 penetrates through the first installation through hole 111 and at least partially extends out of the first installation through hole 111. The upper plastic member 120 is injection-molded on the upper surface of the cover 110, and the upper plastic member 120 includes a first portion 121 and a second portion 122. The first portion 121 is located in the installation through hole 111, and the second portion 122 is located on the upper surface of the cover 110.

Among them, injection molding is a kind of molding including injection and molding, which has advantages of fast production speed, high efficiency, and can be used for mass production and products having complex shapes.

In actual use, a lower plastic member 140 is fixed on the lower surface of the cover 110, and the lower plastic member 140 can be clamped with the limiting portion 132 of the pole 130. The pole body 131 penetrates the cover 110 through the first installation through hole 111, so that at least part of the pole body 131 extends out of the first installation through hole 111. The top cover assembly 100 is fixedly assembled by fixedly connecting the upper plastic member 120 and the pole body 131 which at least partially extends out of the first installation through hole 111.

The upper plastic member 120 is injection-molded on the cover 110, and the first portion 121 of the upper plastic member 120 is located between an outer peripheral surface of the pole body 131 and an inner peripheral surface of the first installation through hole 111, and the second portion 122 of the upper plastic member 120 is located on the upper surface of the cover 110. On the one hand, since the first portion 121 of the upper plastic member 120 is located between the outer peripheral surface of the pole body 131 and the inner peripheral surface of the first installation through hole 111, a diameter of the first installation through hole 111 is larger than a diameter of the pole body 131, so that assembly accuracy between the pole body 131 and the first installation through hole 111 is reduced. On the other hand, by injection molding the upper plastic member 120, the first portion 121 of the upper plastic member 120 can be closely attached and fixed to the outer peripheral surface of the pole body 131 and the inner peripheral surface of the first installation through hole 111 respectively, so that the connection stability between the upper plastic member 120 and the pole 130 and the connection stability between the upper plastic member 120 and the cover 110 are both improved, and stability of installation of the lower plastic member 140 and the pole body 110 is improved. A risk of the upper plastic member 120 being detached from the pole 130 or the cover 110 during the use of the battery 10 is reduced, thereby the service life of the battery 10 is ensured and the usage safety of the battery 10 is improved.

In this embodiment, a cross-section of the pole body 131 is illustrated as being circular, but is not limited thereto. For example, the cross-section of the pole body 131 may also be square, polygonal, etc., and the shape of the first installation through hole 111 corresponds to the shape of the cross-section of the pole body 131. That is, if the cross-section of the pole body 131 is circular, the first installation through hole 111 is also circular.

A length and width of the limiting portion 132 are both larger than the diameter of the pole body 131, and a shape of the limiting portion 132 is not limited, for example, the limiting portion 132 is a square.

It should also be noted that the lower surface of the cover 110 refers to a surface of the cover 110 toward the inside of the casing 300, and the upper surface of the cover 110 refers to a surface of the cover 110 toward the upper plastic member 120. A structural shape of the second portion 122 is not limited. The structural shape of the second portion 122 depends on a shape of an injection mold. As shown in FIG. 6, when the injection mold is a cube, a plane of the injection molded second portion 122 is square.

In some embodiments, the pole body 131 is clamped with the upper plastic member 120, so that firmness of the connection between the pole 130 and the upper plastic member 120 is improved by the pole body 131 and the upper plastic member 120 being clamped.

In order to improve the firmness of the connection between the upper plastic member 120 and the pole body 131, in an exemplary embodiment, as shown in FIG. 4, an engagement structure staggered in a vertical direction is provided between the outer peripheral surface of the pole body 131 and an inner peripheral surface of the upper plastic member 120, and the engagement structure limits movements of the pole 130 in a first direction (shown by an arrow X1 in FIG. 4). The engagement structure includes a first engagement portion 133 arranged on an outer peripheral surface of the pole body 131, and a second engagement portion 125 arranged on the first portion. The first engagement portion 133 is engaged with the second engagement portion 125.

As shown in FIG. 6, the upper plastic member 120 has a second installation through hole 123, and the second installation through hole 123 includes a first through hole and a second through hole that communicate with each other. The first through hole is located in the first portion 121. Since the pole body 131 is provided with a first engagement portion 133, during injection molding of the upper plastic member 120, a second engagement portion 125 will be formed on an inner peripheral surface of the first through hole in the first portion 121. The first engagement portion 133 is engaged with the second engagement portion 125, so that the upper plastic member 120 can be fixedly connected with the pole body 131.

Therefore, the first engagement portion 133 is arranged on the pole body 131, so that the second engagement portion 125 is formed at the first through hole during the injection molding of the upper plastic member 120, and the processing of the second engagement portion 125 is omitted. At the same time, the first engagement portion 133 is engaged with the second engagement portion 125, so that a stable connection between the upper plastic member 120 and the pole body 131 during the use of the battery 10 can be ensured.

In one embodiment, as shown in FIG. 4, FIG. 5 and FIG. 6, the first engagement portion 133 is an annular groove 1311, and the second engagement portion 125 is an annular boss 1251; alternatively, the first engagement portion 133 is an annular boss, and the second engagement portion 125 is an annular groove.

It should be noted that the above-mentioned annular groove refers to a groove opened around the outer peripheral surface of the pole body 131 or around the inner peripheral surface of the first through hole. Similarly, the above-mentioned annular boss refers to a boss arranged around the outer peripheral surface of the pole body 131 or a boss arranged around the inner peripheral surface of the first through hole.

When the first engagement portion 133 is an annular groove 1311, the upper plastic member 120 may enter the annular groove 1311 during the injection molding process, and an annular boss 1251 corresponding to the annular groove 1311 may be formed on the inner peripheral surface of the first through hole. When the first engagement portion 133 is an annular boss, the annular boss is higher than the upper surface of the cover 110. During the injection molding process of the upper plastic member 120, the upper plastic member 120 may enter a space between the upper surface of the cover 110 and the annular boss, thus an annular boss corresponding to the annular groove is formed on the inner peripheral surface of the first through hole. Thereby, the processing of the upper plastic member 120 is simplified.

Further, as shown in FIG. 5 and FIG. 6, in an exemplary embodiment, a peripheral surface of one end of the pole body away from the limiting portion 132 is surrounded with a plurality of limiting grooves 1311a, and an extension direction of the plurality of limiting grooves 1311a and an extension direction of the pole body 131 are parallel. The second portion 122 of the upper plastic member 120 has a plurality of limiting protrusions 1251a, and the plurality of limiting grooves 1311a are engaged with the plurality of limiting protrusions 1251a one by one so as to limit movements of the pole in a second direction (i.e., a direction indicated by an arrow X2 in FIG. 5).

Since the extension direction of each limiting groove 1311a is parallel to the extension direction of the pole body 131, therefore, when the plurality of limiting protrusions 1251a and the plurality of limiting grooves 1311a are engaged with each other one by one, the circumferential direction of the upper plastic member 120 can be limited, thereby preventing circumferential movement of the upper plastic member 120 with respect to the pole body 131.

Optionally, the plurality of limiting grooves 1311a are uniformly distributed (arranged at equal intervals), and the plurality of limiting protrusions 1251a are uniformly distributed.

In another embodiment, the first engagement portion 133 is a plurality of concave portions, the second engagement portion 125 is a plurality of convex portions, and the plurality of convex portions are in one-to-one correspondence with the plurality of concave portions.

By arranging a plurality of concave portions on the outer peripheral surface of the pole body 131, during the injection molding process of the upper plastic member 120, a plurality of convex portions corresponding to the plurality of concave portions may be formed on the inner peripheral surface of the first through hole. Thus, the stability of the connection between the upper plastic member 120 and the pole body 131 is improved while preventing the circumferential movement of the upper plastic member 120 with respect to the pole body 131.

It should be noted that the plurality of concave portions may be arranged around the outer peripheral surface of the pole body 131 to form an annular structure, or the plurality of concave portions may be arrayed on the outer peripheral surface of the pole body 131 in a width direction and a length direction of the pole body 131.

The top cover assembly 100 further includes a sealing ring 150 sleeved on the pole body 131, and an upper surface of the sealing ring 150 includes a first step surface 151 close to the pole body 131 and a second step surface 152 away from the pole body 131. The first step surface 151 abuts against the lower surface of the cover 110, the second step surface 152 abuts against the lower surface of the first portion 121, and a lower surface of the sealing ring 150 abuts against the upper surface of the limiting portion 132.

In this way, the first step surface 151 abuts the lower surface of the cover 110, the second step surface 152 abuts the lower surface of the first portion 121, and the lower surface of the sealing ring 150 abuts the upper surface of the limiting portion 132, so that the electrolyte can be prevented from flowing out through a gap between the lower surface of the cover 110 and the upper surface of the limiting portion 132. Thereby a sealing effect between the lower surface of the cover 110 and the upper surface of the limiting portion 132 is improved, and the sealing property of the top cover assembly 100 is ensured.

Optionally, an inner peripheral surface of the sealing ring 150 is closely attached to the outer peripheral surface of the pole body 131, and an outer peripheral surface of the sealing ring 150 is closely attached to the inner peripheral surface of the first installation through hole 111, so that the electrolyte can be prevented from flowing our through a gap between the inner peripheral surface of the first installation through hole 111 and the outer peripheral surface of the pole body 131. Thus, the sealing effect between the inner peripheral surface of the first installation through hole 111 and the outer peripheral surface of the pole body 131 is ensured.

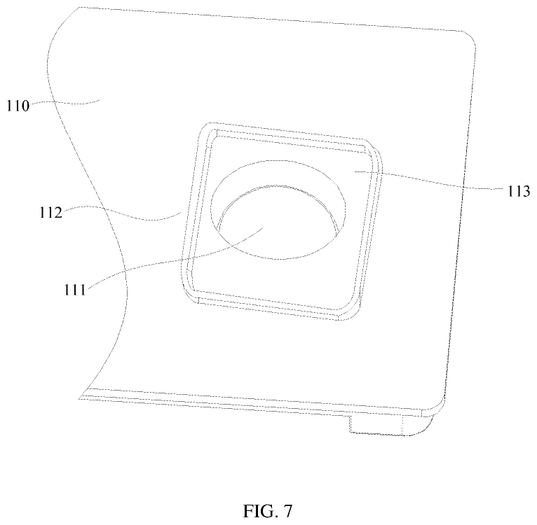

In some embodiments, as shown in FIG. 7, the upper surface of the cover 110 is provided with a protrusion portion 112 surrounding the first installation through hole 111, and the protrusion portion 112 has a shape of a box. A surface of the second portion 122 toward the cover 110 is provided with an accommodation groove 124, and the protrusion portion 112 is engaged with the accommodation groove 124.

Therefore, by arranging the protrusion portion 112 on the upper surface of the cover 110, during a process of injection molding the upper plastic member 120 on the cover 110, the accommodation groove 124 corresponding to the protrusion portion 112 can be formed on the surface of the upper plastic member 120 toward the cover 110. The upper plastic member 120 can be fixedly arranged on the upper surface of the cover 110 by means of the protrusion portion 112 cooperating with the accommodation groove 124, and at the same time, the processing of the upper plastic member 120 is simplified.

In some embodiments, as shown in FIG. 7, the upper surface of the cover 110 is provided with a recessed portion 113, and a part of the surface of the second portion 122 toward the cover 110 is located in the recessed portion 113.

Since a part of the surface of the second portion 122 is located in the recessed portion 113, a height of the second portion 122 can be reduced in a direction perpendicular to the upper surface of the cover 110. Thereby a height of the upper plastic member 120 is reduced, and a height of the top cover assembly 100 is reduced, so that a structure of the top cover assembly 100 is more compact.

In some embodiments, the material of the upper plastic member 120 is PPS plastic.

PPS plastic is a thermoplastic special engineering plastic with excellent comprehensive properties, which has advantages of high temperature resistance, corrosion resistance and excellent mechanical properties.

Therefore, by selecting PPS plastic as a molding material of the upper plastic member 120, high temperature resistance and corrosion resistance of the upper plastic member 120 can be effectively improved, so that a service life of the upper plastic member 120 is improved, and a service life of the top cover assembly 100 is increased.

In some embodiments, a melting point of the upper plastic member 120 is 250° C. to 300° C.

For example, the melting point of the upper plastic member 120 is 250° C., 260° C., 270° C., 280° C., 290° C., 300° C., and the like.

If the melting temperature of the upper plastic member 120 is greater than 300° C., when the upper plastic member 120 is injection-molded on the upper surface of the cover 110, the excessively high temperature may affect the cover 110, the lower plastic member 140, etc. For example, the lower plastic member 140 melts, so that the lower plastic member 140 is deformed, thereby affecting the assembly effect. If the melting temperature of the upper plastic member 120 is lower than 250° C., a melting effect of the PPS plastic is poor. For example, the PPS plastic is not completely melted, and the molding quality of the upper plastic member 120 may be affected during the molding of the upper plastic member 120. Therefore, when the melting point of the upper plastic member 120 is between 250° C. and 300° C., the upper plastic member 120 can be completely melted, and an assembly quality of the top cover assembly 100 can be ensured.

For example, the melting point of the upper plastic member 120 is 280° C.

In the battery 10, the pole 130 includes a positive pole 130a and a negative pole 130b. In order to fix the positive pole 130a and the negative pole 130b respectively, in an embodiment, the upper plastic member 120 includes a positive electrode upper plastic member 120a and a negative electrode upper plastic member 120b, and a material of the positive electrode upper plastic member 120b further includes conductive carbon.

Therefore, the positive electrode upper plastic member 120a can fix an end of a positive pole 130a away from the limiting portion 132, and the negative electrode upper plastic member 132b can fix an end of a negative pole 130b away from the limiting portion 132.

In addition, a material of the limiting portion of the positive pole 130a is aluminum, and a material of the limiting portion of the negative pole 130b is copper, and conductivity of copper is stronger than that of aluminum. Therefore, in order to ensure consistency of the conductivities of the positive pole 130a and the negative pole 130b, it is necessary to improve the conductivity of the positive pole 130a. In this embodiment, since the conductive carbon has conductivity, by doping the conductive carbon in the positive electrode upper plastic member 120a, a resistance of the positive electrode upper plastic member 120a can be reduced to a certain extent, thereby the consistency of the conductivities of the positive pole 130a and the negative pole 130b is ensured.

It should be noted that the conductive carbon refers to carbon black with low resistance or high resistance, which can make rubber or plastic have certain conductive properties. The type of the conductive carbon is not limited here, for example, the conductive carbon is graphite.

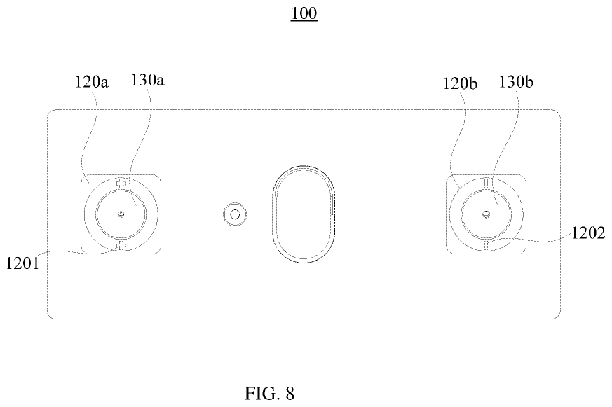

In order to facilitate the distinction between the positive electrode upper plastic member 120a and the negative electrode upper plastic member 120b, a positive electrode logo is engraved on the positive electrode upper plastic member 120a, and a negative electrode logo is engraved on the negative electrode upper plastic member 120b. In an exemplary embodiment, as shown in FIG. 8, the negative electrode logo is a longitudinal groove 1202, and the positive electrode logo is a cross-shaped groove 1201.

It should be noted that a formation method of the longitudinal groove 1202 and the cross-shaped groove 1201 is not limited. For example, the longitudinal groove 1202 and the cross-shaped groove 1201 are formed by engraving. Alternatively, a cross-shaped convex portion is provided on an inner surface of a mold for forming the positive electrode upper plastic member 120a, and a longitudinal convex portion is provided on an inner surface of a mold for forming the negative electrode upper plastic member 120b, during a molding process of the positive electrode upper plastic member 120a and the negative electrode upper plastic member 120b, a cross-shaped groove 1201 will be formed on the surface of the positive electrode upper plastic member, and a longitudinal groove 1202 will be formed on the surface of the negative electrode upper plastic member.

When the top cover assembly 100 is applied to the battery 10, a connecting piece is welded and fixed to the pole bodies 131 in adjacent top cover assemblies 100, so as to realize a electrical connection of the two batteries 10. In a process of welding and fixing the connecting piece to the pole bodies 131, an external detector is usually used to detect alignment information between the connecting piece and the pole body 131, so as to facilitate accurate welding. However, in the related art, the connecting piece is provided with a through hole, and the external detector detects the pole body 131 through the through hole. Due to floating of a position of the connecting piece and an error of installation of the pole body 131, the consistency of welding positions detected by the external connection detector is poor. Therefore, there is a risk of a welding equipment deviating from the pole body 131 and performing the welding. Based on this, a positioning concave hole is provided on an end face of an end of the pole body 131 away from the limiting portion 132 to improve a welding stability of the pole body 131 and the connecting piece.

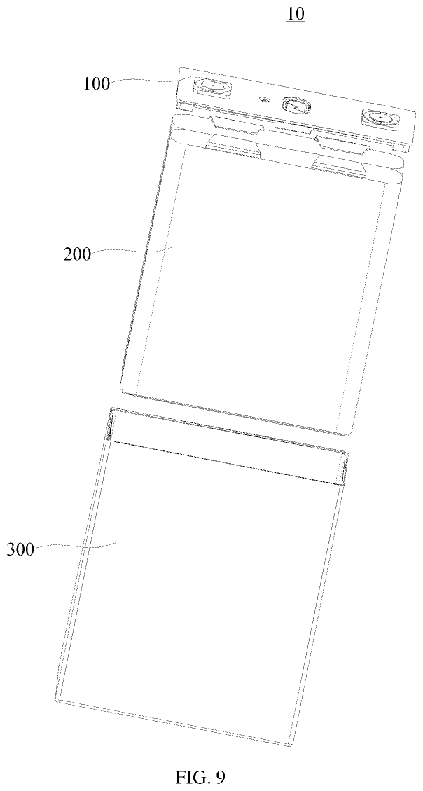

The embodiment of the present application further provides a battery 10, as shown in FIG. 9, the battery 10 includes the above-mentioned top cover assembly 100.

Since the battery provided in this embodiment adopts the above-mentioned top cover assembly 100, this embodiment can improve the service life and usage safety of the battery by improving the connection stability between the pole and the upper plastic member.

In some embodiments, the battery 10 further includes a casing 300 and an electrode assembly 200 accommodated in the casing 300.

An accommodating cavity 320 is formed inside the casing 300 for accommodating the electrode assembly 200 and the electrolyte. One end of the casing 300 has an opening 310 so that the electrode assembly 200 can be placed in the accommodating cavity 320 of the casing 300 through the opening 310. A plurality of electrode assemblies 200 can be arranged in the accommodating cavity 320. The plurality of cells 200 are stacked and electrically connected with each other, and the top cover assembly 100 is sealed at the opening 310 of the casing 300 to prevent the electrolyte from leaking out.

Since a plurality of electrode assemblies 200 can be stacked in the accommodating cavity 320 of the housing 300, and each adjacent two electrode assemblies 200 are electrically connected. Optionally, every two adjacent electrode assemblies 200 are connected through a switch piece.

It should be noted that, the above-mentioned casing 300 may be hexahedral or other shapes. A material of the casing 300 may be a metal material, such as aluminum or aluminum alloy, or an insulating material, such as plastic.

The electrode assembly 200 is formed by stacking and winding a positive pole piece, a separator and a negative pole piece in sequence.

Exemplarily, the electrode assembly 200 is used to prepare a 280 Ah battery, where a starting end of the negative pole piece exceeds a starting end of the positive pole piece, and an ending end of the negative pole piece exceeds an ending end of the positive pole piece, so as to ensure that both the starting end and the ending end of the negative pole piece exceed the starting end and the ending end of the positive pole piece. Compared with an arrangement where both the starting end and the ending end of the negative pole piece are aligned with the starting end and the ending end of the positive pole piece in the related art, lithium ions detached from the positive pole piece can be smoothly inserted into the negative pole piece when the electrode assembly 200 is charged, so as to reduce the occurrence of a lithium precipitation phenomenon and improve the usage safety of the electrode assembly 200. The situation that the starting end of the negative pole piece exceeds the starting end of the positive pole piece much, and the ending end of the negative pole piece exceeds the ending end of the positive pole piece much can be avoided, thereby waste of materials of the negative pole piece is reduced and the cost is saved.

Since the electrolyte is in the accommodating cavity 320 of the casing 300, and the positive pole piece and the negative pole piece can be in contact with the electrolyte, the positive pole piece and the negative pole piece can undergo a redox reaction when the battery 10 is charged.

In some embodiments, the material of the positive pole piece is aluminum, and the material of the negative pole piece is copper.

Since chemical properties of aluminum are relatively active, during the charging process of the battery 100, the aluminum can quickly lose electrons and undergo an oxidation reaction. Chemical properties of copper are relatively stable, and can obtain electrons to undergo a reduction reaction during the charging process of the battery 100.

Finally, it should be noted that: each of the above embodiments is merely used for illustrating rather than limiting the technical solutions of the present application. Although the present application is illustrated in detail with reference to each of the foregoing embodiments, those of ordinary skill in the art should understand that they can still modify the technical solutions described in the foregoing embodiments, or make equivalent substitutions to some of or all of the technical features therein, but these modifications or substitutions can be made to the respective technical solutions without departing from the scope of the technical solutions of the embodiments of the present application.

What is claimed is:

1. A top cover assembly comprising:
a cover, provided with a first installation through hole;
a pole, configured to penetrate through the first installation through hole, wherein an end of the pole is higher than an upper surface of the cover; and
an upper plastic member, located on the upper surface of the cover and provided with a second installation through hole, the pole further penetrating through the second installation through hole.

2. The top cover assembly according to claim 1, wherein:
the upper plastic member comprises a first portion and a second portion,
the second portion is located on the upper surface of the cover, and
the first portion is located in the first installation through hole.

3. The top cover assembly according to claim 2, wherein:
the pole comprises a pole body and a limiting portion connected to an end of the pole body,
the limiting portion abuts against a lower surface of the cover, and
the pole body is engaged with the upper plastic member.

4. The top cover assembly according to claim 3, wherein:
an engagement structure is provided between an outer peripheral surface of the pole body and an inner peripheral surface of the second installation through hole of the upper plastic member,
the engagement structure is configured to limit movements of the pole in a first direction,
the engagement structure comprises a first engagement portion arranged on the outer peripheral surface of the pole body and a second engagement portion arranged on the first portion of the upper plastic member, and
the first engagement portion is engaged with the second engagement portion.

5. The top cover assembly according to claim 4, wherein:
the first engagement portion comprises an annular groove and the second engagement portion comprises an annular boss; or
the first engagement portion comprises an annular boss and the second engagement portion comprises an annular groove.

6. The top cover assembly according to claim 3, wherein:
an end of an outer peripheral surface of the pole body away from the limiting portion is provided with a plurality of limiting grooves disposed circumferentially,
an extension direction of each limiting groove is parallel to an extension direction of the pole body,
the upper plastic member has a plurality of limiting protrusions disposed on a part of an inner peripheral surface of the second installation through hole located in the second portion, and
the plurality of limiting grooves are engaged with the plurality of limiting protrusions, respectively.

7. The top cover assembly according to claim 3, wherein:
the top cover assembly further comprises a sealing ring circumferentially disposed on the outer peripheral surface of the pole body,
an upper surface of the sealing ring comprises a first step surface close to the pole body and a second step surface away from the pole body,
the first step surface abuts against a lower surface of the first portion of the upper plastic member,
the second step surface abuts against the lower surface of the cover, and
a lower surface of the sealing ring abuts against an upper surface of the limiting portion of the pole.

8. The top cover assembly according to claim 2, wherein:
the upper surface of the cover is provided with a protrusion portion surrounding the first installation through hole,
a surface of the second portion of the upper plastic member toward the cover is provided with an accommodation groove, and
the protrusion portion is inserted in the accommodation groove.

9. The top cover assembly according to claim 8, wherein:
the upper surface of the cover is provided with a recessed portion, and
a portion of a surface of the second portion of the upper plastic member toward the cover is located in the recessed portion.

10. The top cover assembly according to claim 1, wherein material of the upper plastic member further comprises conductive carbon.

11. A battery comprising a top cover assembly, wherein the top cover assembly comprises:
a cover, provided with a first installation through hole;
a pole, configured to penetrate through the first installation through hole, wherein an end of the pole is higher than an upper surface of the cover; and
an upper plastic member, located on the upper surface of the cover and provided with a second installation through hole, the pole further penetrating through the second installation through hole.

12. The battery according to claim 11, wherein:
the upper plastic member comprises a first portion and a second portion,
the second portion is located on the upper surface of the cover, and
the first portion is located in the first installation through hole.

13. The battery according to claim 12, wherein:
the pole comprises a pole body and a limiting portion connected to an end of the pole body,
the limiting portion abuts against a lower surface of the cover, and
the pole body is engaged with the upper plastic member.

14. The battery according to claim 13, wherein:
an engagement structure is provided between an outer peripheral surface of the pole body and an inner peripheral surface of the second installation through hole of the upper plastic member,
the engagement structure is configured to limit movements of the pole in a first direction,
the engagement structure comprises a first engagement portion arranged on the outer peripheral surface of the pole body and a second engagement portion arranged on the first portion of the upper plastic member, and
the first engagement portion is engaged with the second engagement portion.

15. The battery according to claim 14, wherein:
the first engagement portion comprises an annular groove and the second engagement portion comprises an annular boss; or
the first engagement portion comprises an annular boss and the second engagement portion comprises an annular groove.

16. The battery according to claim 13, wherein:
one end of an outer peripheral surface of the pole body away from the limiting portion is provided with a plurality of limiting grooves disposed circumferentially,
an extension direction of each limiting groove is parallel to an extension direction of the pole body,
the upper plastic member has a plurality of limiting protrusions disposed on a part of an inner peripheral surface of the second installation through hole located in the second portion, and
the plurality of limiting grooves are engaged with the plurality of limiting protrusions, respectively.

17. The battery according to claim 13, wherein:
the top cover assembly further comprises a sealing ring circumferentially disposed on the outer peripheral surface of the pole body,
an upper surface of the sealing ring comprises a first step surface close to the pole body and a second step surface away from the pole body,
the first step surface abuts against a lower surface of the first portion of the upper plastic member,
the second step surface abuts against the lower surface of the cover, and
a lower surface of the sealing ring abuts against an upper surface of the limiting portion of the pole.

18. The battery according to claim 12, wherein:
the upper surface of the cover is provided with a protrusion portion surrounding the first installation through hole,
a surface of the second portion of the upper plastic member toward the cover is provided with an accommodation groove, and
the protrusion portion is inserted in the accommodation groove.

19. The battery according to claim 18, wherein:
the upper surface of the cover is provided with a recessed portion, and
a portion of a surface of the second portion of the upper plastic member toward the cover is located in the recessed portion.

20. The battery according to claim 11, wherein material of the upper plastic member further comprises conductive carbon.
